(19) United States
(12) Patent Application Publication
(10) Pub. No.: US 2007/0237047 A1
(43) Pub. Date: Oct. 11, 2007

(54) METHODS AND SYSTEMS FOR IDENTIFYING DIGITAL VIDEO DISC TYPE

(75) Inventor: Shin Min Hsiang, Taichung County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/697,144

(22) Filed: Apr. 5, 2007

(30) Foreign Application Priority Data
Apr. 10, 2006 (TW) TW95112628

(51) Int. Cl. G11B 27/36

(52) U.S. Cl. 369/53.2

(57) ABSTRACT

A method for identifying digital video disc (DVD) type identification is employed in a digital disc writing apparatus. Optical data is read from a DVD. Wobble signal amplitude and the maximum amplitude are calculated according to the read data. It is determined whether the difference between the wobble signal amplitude and the maximum amplitude exceeds a predetermined threshold. If so, the DVD is determined as a first type, otherwise, as a second type.

### BACKGROUND OF THE INVENTION

1. Field of the Invention

The invention relates to a method for identifying optical media discs, and in particular to a method for identifying digital video disc type.

2. Description of the Related Art

Recordable digital video discs (DVD) are mainly divided into two specifications. One specification, such as a DVD-R and a DVD-RW, is established by DVD Forum, called as first type. The other specification, such as a DVD+R and a DVD+RW, is established by DVD Alliance, called as second type.

For a DVD recorder, in order to write or process data on a disc, the first type and second type must be identified. In general, a frequency of a DVD is the basis for identification. The difference between frequencies of a first type DVD and a second type DVD is large. In practice, when the identification is performed according to a frequency of a DVD, if the difference between frequencies of two DVDs is great, the identification is not accurately accomplished.

When a DVD recorder can not identify a first type DVD and a second type DVD, the DVD recorder does not continuously perform follow-up operations. Thus, it is important to identify various types of DVDs in a DVD recorder.

### BRIEF SUMMARY OF THE INVENTION

An exemplary embodiment of a method for identifying digital video disc (DVD) type is provided. First, optical data is read from a DVD. Wobble signal amplitude and the maximum amplitude are calculated according to the read optical data. The optical data on the DVD is generated by optical projection from a read-write device, such as pick-up head, to the DVD. The optical data comprises a push and pull normalize signal (PPN), which is calculated by:

PPN=G1×(A+B)−G2×(C+D)

In above formula, PPN represents a push and pull normalize signal, (A+B) represents a first-area data of the DVD, (C+D) represents a second-area data of the DVD, and G1 and G2 are regulation constants.

It is determined whether the difference between the wobble signal amplitude and the maximum amplitude exceeds a predetermined threshold. When the difference exceeds the predetermined threshold, the DVD is determined as a first type. When the difference is less than the predetermined threshold, the DVD is determined as a second type. The first type comprises DVD-R and DVD-RW. The second type comprises DVD+R and DVD+RW. The difference is determined according to the formula P_{w}>r×_{Pmax}, wherein P_{w} represents the wobble signal amplitude, Pₘₐₓ represents the maximum amplitude, and r represents a predetermined constant larger than zero.

An exemplary embodiment of a storage medium is provided. The storage medium stores a computer program providing a method for identifying digital video disc (DVD) type, comprising using a computer to perform the above steps.

An exemplary embodiment of a system for identifying digital video disc (DVD) type is provided. The system comprises a processing unit reading optical data from a DVD and calculating wobble signal amplitude and the maximum amplitude according to the read optical data. The optical data on the DVD is generated by optical projection from a read-write device, such as pick-up head, to the DVD. The optical data comprises a push and pull normalize signal (PPN), which is calculated by:

PPN=G1×(A+B)−G2×(C+D)

In above formula, PPN represents a push and pull normalize signal, (A+B) represents a first-area data of the DVD, (C+D) represents a second-area data of the DVD, and G1 and G2 are regulation constants.

Then, the processing unit determines whether the difference between the wobble signal amplitude and the maximum amplitude exceeds a predetermined threshold. When the difference exceeds the predetermined threshold, the processing unit determines the DVD as the first type. When the difference is smaller than the predetermined threshold, the processing unit determines the DVD as the second type. The processing unit determines the difference according to a formula P_{w}>r×Pₘₐₓ, where P_{w} represents the wobble signal amplitude, Pₘₐₓ represents the maximum amplitude, and r represents a predetermined constant larger than zero. The first type comprises DVD-R and DVD-RW, and the second type comprises DVD+R and DVD+RW. The processing unit is implemented by a chip.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1a is a diagram of optical data of a DVD;

FIGS. 1b and 1c show PPN;

FIG. 2 is a flow chart of an exemplary embodiment of a method for identifying DVD type;

FIG. 3 depicts an embodiment of a storage medium;

FIG. 4 is a function block diagram of an embodiment of a system for identifying DVD type; and

FIG. 5 depicts an embodiment of a method for identifying DVD type, applied in a DVD recorder.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

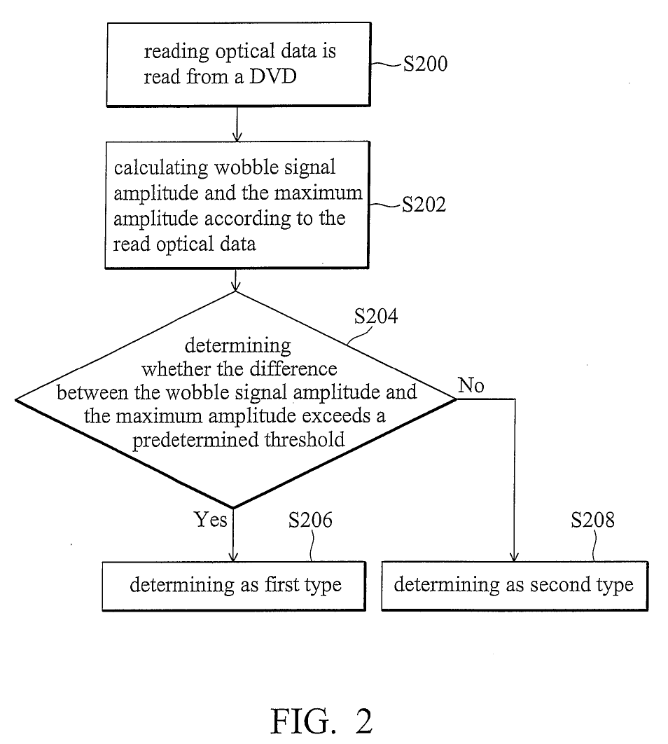

Methods for identifying digital video disc (DVD) type are provided. FIG. 2 is a flow chart of an exemplary embodiment of a method for identifying DVD type, which can be applied in a DVD recorder to identify various types of digital video discs.

First, optical data is read from a DVD (step S200). Wobble signal amplitude and the maximum amplitude are calculated according to the read optical data (step S202). The optical data on the DVD is generated by optical projection from a read-write device, such as a pick-up head, to the DVD. The optical data comprises a push and pull normalize signal (PPN), which is calculated by:

PPN=G1×(A+B)−G2×(C+D)

In above formula, PPN represents a push and pull normalize signal, (A+B) represents a first-area data of the DVD, (C+D) represents a second-area data of the DVD, and G1 and G2 are regulation constants.

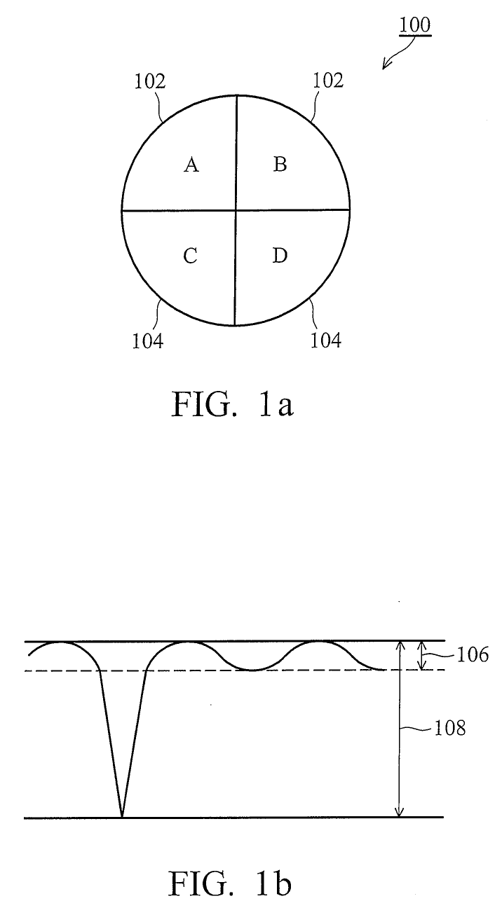

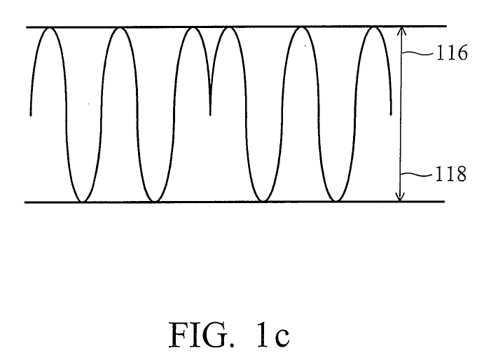

FIG. 1a is a diagram of the optical data of the DVD. Referring to FIG. 1a, an area 100 represents the optical data generated by optical projection from a pick-up head. The area 100 is divided into a first area 102 and a second area 104. The first area 102 is composed of areas A and B, and the second area 104 is composed of areas C and D. By setting the regulation constants G1 and G2, the PPN is calculated according to the formula

PPN=G1×(A+B)−G2×(C+D).

Then, it is determined whether the difference between the wobble signal amplitude and the maximum amplitude exceeds a predetermined threshold (step S204). When the difference exceeds the predetermined threshold, the DVD is determined as a first type (step S206). When the difference is smaller than the predetermined threshold, the DVD is determined as a second type (step S208). The first type comprises DVD-R and DVD-RW. The second type comprises DVD+R and DVD+RW. The difference is determined according to the formula P_{w}>r×Pₘₐₓ, wherein P_{w} represents the wobble signal amplitude, Pₘₐₓ represents the maximum amplitude, and r represents a predetermined constant larger than zero.

An example is described according to FIGS. 1b and 1c. FIG. 1b shows a PPN of a first type DVD, such as DVD-R and RVR-RW. Referring to FIG. 1b, the difference between the wobble signal amplitude 106 and the maximum amplitude 108 is large. FIG. 1c shows a PPN of a second type DVD, such as DVD+R and RVR+RW. Referring to FIG. 1c, the difference between the wobble signal amplitude 116 and the maximum amplitude 118 is very small.

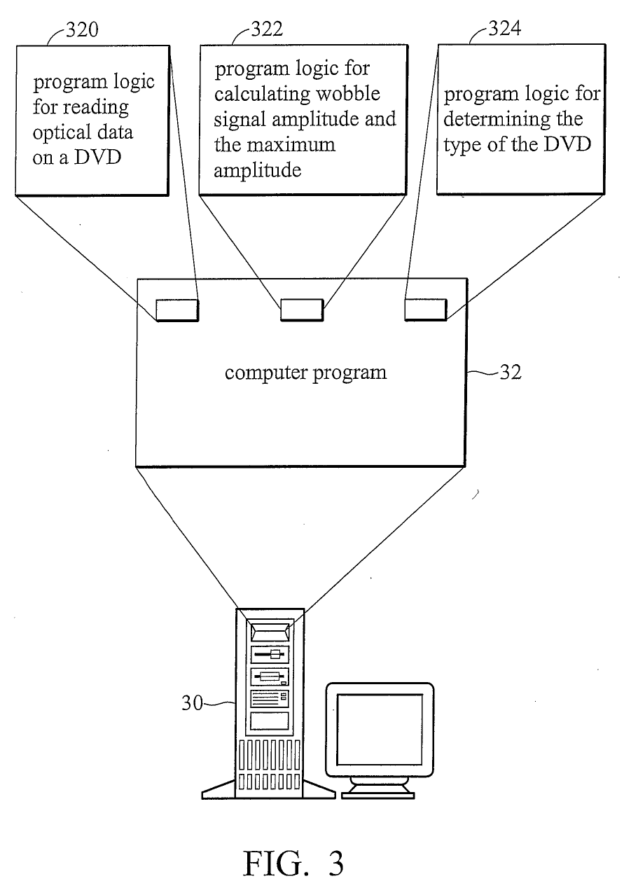

FIG. 3 depicts an embodiment of a storage medium. Referring to FIG. 3, a storage medium 30 storing a computer program 32 is provided. The computer program 32 is loaded to a computer system, and the computer system performs the method for identifying DVD type. The computer program 32 comprises a program logic 320 for reading optical data on a DVD, a program logic 322 for calculating wobble signal amplitude and the maximum amplitude, and a program logic 324 for determining the type of the DVD.

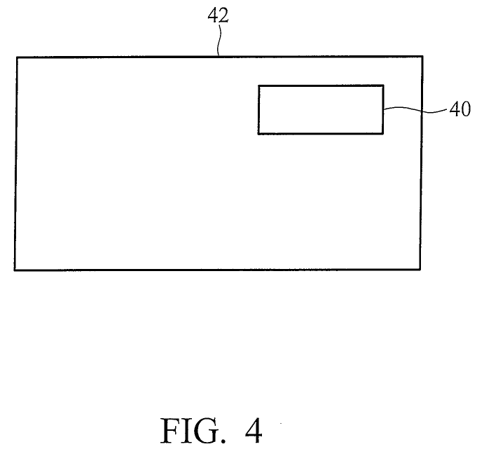

FIG. 4 is a function block diagram of an embodiment of a system for identifying DVD type. The system comprises a processing unit 410. The processing unit 410 reads optical data on a DVD and then calculates wobble signal amplitude and the maximum amplitude according to the read optical data.

The optical data on the DVD is generated by optical projection from a read-write device, such as a pick-up head, to the DVD. The optical data comprises a push and pull normalize signal (PPN), which is calculated by:

PPN=G1×(A+B)−G2×(C+D)

In the above formula, PPN represents a push and pull normalize signal, (A+B) represents a first-area data of the DVD, (C+D) represents a second-area data of the DVD, and G1 and G2 are regulation constants.

The processing unit 40 determines whether the difference between the wobble signal amplitude and the maximum amplitude exceeds a predetermined threshold (step S204). When the difference exceeds the predetermined threshold, the DVD is determined as a first type. When the difference is smaller than the predetermined threshold, the DVD is determined as a second type. The processing unit 40 determines whether the difference between the wobble signal amplitude and the maximum amplitude according to the following formula:

P_{w}>r×Pₘₐₓ

P_{w} represents the wobble signal amplitude, Pₘₐₓ represents the maximum amplitude, and r represents a predetermined constant larger than zero. The first type comprises DVD-R and DVD-RW. The second type comprises DVD+R and DVD+RW. The processing unit 40 can be implemented by a chip. As shown in FIG. 4, the processing unit 40 is disposed in a DVD recorder 42.

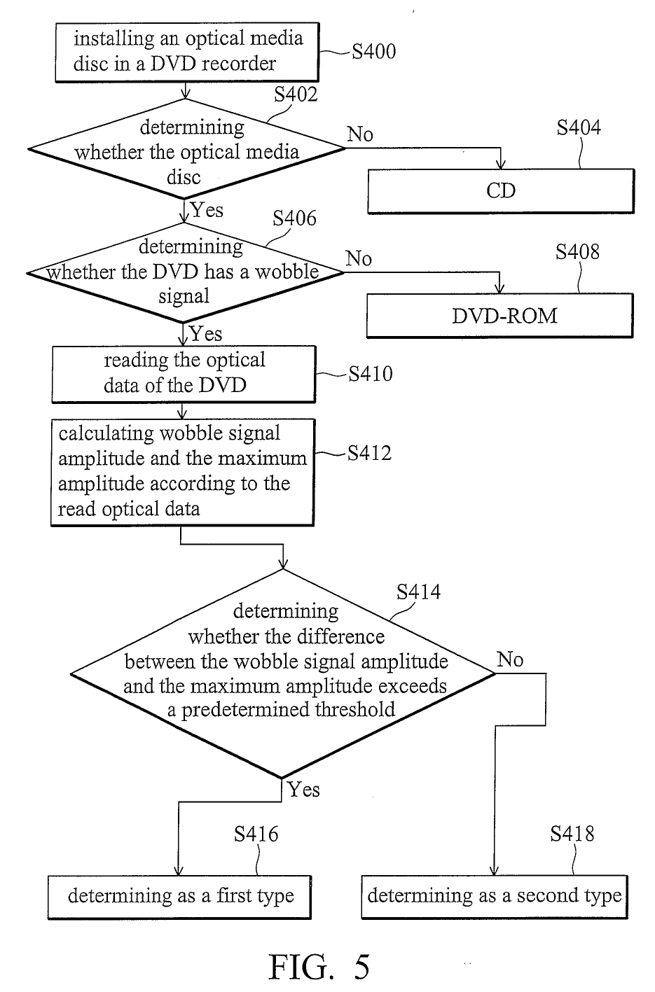

FIG. 5 depicts an embodiment of a method for identifying DVD type, and the method is applied in a DVD recorder to identify various types of digital video discs.

First, an optical media disc is installed in the DVD recorder (step S400). The DVD recorder determines whether the optical media disc is a DVD (step S402). When the DVD recorder determines that the optical media disc is not a DVD, the DVD recorder classifies the optical media disc as a CD (step S404) and processes the CD accordingly.

When the DVD recorder determines that the optical media disc is a DVD, the DVD recorder determines whether the DVD has a wobble signal (step S406). When the DVD recorder determines that the DVD does not have a wobble signal, the DVD is determined to be a DVD-ROM (step S408).

Then, the optical data of the DVD is read (step S410). Wobble signal amplitude and the maximum amplitude are calculated according to the read optical data (step S412). The optical data on the DVD is generated by optical projection from a read-write device, such as a pick-up head, to the DVD. The optical data comprises a push and pull normalize signal (PPN), which is calculated by:

PPN=G1×(A+B)−G2×(C+D)

In the above formula, PPN represents a push and pull normalize signal, (A+B) represents a first-area data of the DVD, (C+D) represents a second-area data of the DVD, and G1 and G2 are regulation constants.

Then, it is determined whether the difference between the wobble signal amplitude and the maximum amplitude exceeds a predetermined threshold (step S414). When the difference exceeds the predetermined threshold, the DVD is determined as a first type (step S416). When the difference is smaller than the predetermined threshold, the DVD is determined as a second type (step S418). The first type comprises DVD-R and DVD-RW. The second type comprises DVD+R and DVD+RW. The difference is determined according to the formula P_{w}>r×Pₘₐₓ, wherein P_{w} represents the wobble signal amplitude, Pₘₐₓ represents the maximum amplitude, and r represents a predetermined constant larger than zero. After the steps S416 and S418, if tie optical media disc is determined as the first type, the frequency of the optical media disc is set as (n×844) kHz. IF the optical media disc is determined as the second type, the frequency of the optical media disc is set as (n×104.1) kHz. According to the frequency of the optical media disc, the DVD recorder performs subsequently.

As above described, the provided method can effectively identify DVD type, and follow-up processes or recording are accordingly performed.

A method and system of the invention, or certain aspects or portions of embodiments thereof, may take the form of program code (i.e., instructions) embodied in media, such as floppy discettes, CD-ROMS, hard drives, firmware, or any other storage medium, wherein. When the program code is loaded into and executed by a machine, such as a computer, the machine becomes an apparatus for practicing and embodiment of the invention. The method and system of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for identifying digital video disc (DVD) type, comprising:
reading an optical data from a DVD;
calculating a wobble signal amplitude and a maximum amplitude according to the read optical data;
determining whether a difference between the wobble signal amplitude and the maximum amplitude exceeds a predetermined threshold;
determining the DVD as a first type when the difference exceeds the predetermined threshold; and
determining the DVD as a second type when the difference is smaller than the predetermined threshold.

2. The method as claimed in claim 1, wherein the optical data on the DVD is generated by optical projection from a read-write device to the DVD.

3. The method as claimed in claim 1, wherein the optical data comprises a push and pull normalize signal (PPN), which is calculated by:
PPN=G1×(A+B)−G2×(C+D); and
wherein PPN represents a push and pull normalize signal, (A+B) represents a first-area data of the DVD, (C+D) represents a second-area data of the DVD, and G1 and G2 are regulation constants.

4. The method as claimed in claim 1, wherein the difference is determined according to a formula P_{w}>r×Pₘₐₓ, P_{w} represents the wobble signal amplitude, Pₘₐₓ represents the maximum amplitude, and r represents a predetermined constant larger than zero.

5. The method as claimed in claim 1, wherein the first type comprises DVD-R and DVD-RW.

6. The method as claimed in claim 1, wherein the second type comprises DVD+R and DVD+RW.

7. A storage medium for storing a computer program providing a method for identifying digital video disc (DVD) type, comprising using a computer to perform the steps claimed in claim 1.

8. A system for identifying digital video disc (DVD) type, comprising:
a processing unit reading an optical data from a DVD, calculating a wobble signal amplitude and a maximum amplitude according to the read optical data, and determining whether a difference between the wobble signal amplitude and the maximum amplitude exceeds a predetermined threshold;
wherein the processing unit determines the DVD as first type when the difference exceeds the predetermined threshold and determines the DVD as second type when the difference is smaller than the predetermined threshold.

9. The system as claimed in claim 8, wherein the optical data on the DVD is generated by optical projection from a read-write device to the DVD.

10. The system as claimed in claim 8, wherein the optical data comprises a push and pull normalize signal (PPN), which is calculated by:
PPN=G1×(A+B)−G2×(C+D); and
wherein PPN represents a push and pull normalize signal, (A+B) represents a first-area data of the DVD, (C+D) represents a second-area data of the. DVD, and G1 and G2 are regulation constants.

11. The system as claimed in claim 8, wherein the processing unit determined the difference according to a formula P_{w}>r×Pₘₐₓ, P_{w} represents the wobble signal amplitude, Pₘₐₓ represents the maximum amplitude, and r represents a predetermined constant larger than zero.

12. The system as claimed in claim 8, wherein the first type comprises DVD-R and DVD-RW.

13. The system as claimed in claim 8, wherein the second type comprises DVD+R and DVD+RW.

14. The system as claimed in claim 8, wherein the processing unit is implemented by a chip.
